(19) United States
(12) Patent Application Publication
(10) Pub. No.: US 2010/0045192 A1
(43) Pub. Date: Feb. 25, 2010

(54) METHOD FOR DRIVING LIGHT SOURCE, LIGHT SOURCE APPARATUS FOR PERFORMING THE METHOD AND DISPLAY APPARATUS HAVING THE LIGHT SOURCE APPARATUS

(75) Inventors: Yo-Han LEE, Asan-si (KR); Hyun-Seok HONG, Daejeon (KR); Jin-Young OH, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, Gyeonggi-do (KR)

(21) Appl. No.: 12/544,374

(22) Filed: Aug. 20, 2009

(30) Foreign Application Priority Data
Aug. 21, 2008 (KR) 2008-81752

(51) Int. Cl. H05B 37/02; H05B 41/36

(52) U.S. Cl. 315/152; 315/149; 315/294

(57) ABSTRACT

A method for driving a light source includes providing a first control voltage at a first level to a memory so that the memory performs a writing operation when an external control signal is received by a control voltage generating circuit, providing a second control voltage at a second level to the memory so that the memory prevents the writing operation when the external control signal is not received by the control voltage generating circuit, comparing a reference signal stored in the memory with a sensing signal based on an amount of light outputted from the light source to generate a driving signal, and providing the driving signal to the light source to compensate the amount of light outputted from the light source.

This application claims priority to Korean Patent Application No. 2008-81752, filed on Aug. 21, 2008, and all the benefits accruing therefrom under 35 U.S.C. §119, the contents of which in its entirety are herein incorporated by reference.

### BACKGROUND OF THE INVENTION

1. Field of the Invention

The present invention relates to a method for driving a light source, a light source apparatus for performing the method and a display apparatus having the light source apparatus. More particularly, the present invention relates to a method resulting in substantially reduced noise generated while driving a light source used in a liquid crystal display (“LCD”) apparatus, a light source apparatus for performing the method, and a display apparatus having the light source apparatus.

2. Description of the Related Art

Generally, a liquid crystal display (“LCD”) apparatus includes an LCD panel which displays an image thereon by controlling light transmissivity of liquid crystal in the LCD panel, and a light source apparatus disposed below the LCD panel to provide light to the LCD panel.

In general, the light source apparatus includes a light source which generates light. Typical examples of the light source include a cold cathode fluorescent lamp (“CCFL”), a flat fluorescent lamp (“FFL”) and a light-emitting diode (“LED”), for example. Moreover, the LED is often used as the light source of the LCD apparatus, since the LED has low power consumption and high color reproducibility relative to other types of light sources.

The light source apparatus having LEDs performs white balance correction for increasing the color reproducibility. Thus, the light source apparatus typically includes a memory, in which reference signals for white balance correction are stored, and corrects the white balance of the light source being driven using the reference signals stored in the memory.

The reference signals stored in the memory are typically acquired through a test process performed during manufacturing, e.g., before the display apparatus is completed into a finished product. Thereafter, the reference signals based on the test process are stored in the memory and the light source is driven. In some cases, color reproduction is not satisfactory, and the reference signals go through a series of processes to renew, e.g., to adjust and/or correct, the reference signals. Accordingly, a rewritable memory is generally employed as the memory, and a write protection function of the memory is not typically used, since the reference signals may need to be changed through the series of processes, as described above. Thus, the memory is always in a writable state.

However, when the memory is always in the writable state, a problem occurs. Specifically, electrical noise is generated and flows through an input/output terminal of the memory. As a result, the reference signals stored in the memory are damaged, e.g., become changed or degraded. When the reference signals stored in the memory are changed or damaged, white balance correction for driving the light source is not satisfactorily performed, and a display quality of an image is thereby deteriorated.

### BRIEF SUMMARY OF THE INVENTION

Exemplary embodiments of the present invention provide a method for driving a light source having a substantially improved reliability and display quality.

Exemplary embodiments of the present invention also provide a light source apparatus for performing the method.

Exemplary embodiments of the present invention also provide a display apparatus including the light source apparatus.

According to an exemplary embodiment of the present invention, there is provided a method for driving a light source. The method includes providing a first control voltage at a first level to a memory so that the memory performs a writing operation when an external control signal is received by a control voltage generating circuit, providing a second control voltage at a second level to the memory so that the memory prevents the writing operation when the external control signal is not received by the control voltage generating circuit, comparing a reference signal stored in the memory with a sensing signal based on an amount of light outputted from the light source to generate a driving signal, and providing the driving signal to the light source to compensate the amount of light outputted from the light source.

According to an alternative exemplary embodiment of the present invention, a light source apparatus includes a light source module, a memory and a control voltage generating circuit. The light source module includes a plurality of light sources. The memory includes a writing control terminal and is configured to store a plurality of reference signals for white balance correction of light sources of the plurality of light sources. The control voltage generating circuit provides a first control voltage at a first level to the writing control terminal when an external control signal is received, and provides a second control voltage at a second level to the writing control terminal when the external control signal is not received.

In an exemplary embodiment, the control voltage generating circuit includes a signal input part, a resistor and a capacitor. The signal input part receives an external control signal from an external device. A first terminal of the resistor is connected to an input power voltage and a second terminal of the resistor is connected to the signal input part and the writing control terminal. A first terminal of the capacitor is connected to the second terminal of the resistor and a second terminal of the capacitor is connected to a ground voltage.

According to another alternative exemplary embodiment of the present invention, a display apparatus includes a display panel, a light source module and a light source driving part. The display panel displays an image. The light source module is disposed on a first printed circuit board (“PCB”) and includes a plurality of light sources which generate light to provide the light to the display panel. The light source driving part is disposed on a second PCB and includes a memory and a control voltage generating circuit. The memory includes a writing control terminal and stores a reference signal for white balance correction of light sources of the plurality of light sources. The control voltage generating circuit provides a first control voltage at a first level to the writing control terminal when an external control signal is received and provides a second control voltage at a second level to the writing control terminal when the external control signal is not received to control a writing operation of the memory.

According to exemplary embodiments of the present invention, in a method for driving a light source, a light source apparatus for performing the method and a display apparatus having the light source apparatus, a writing operation of a memory is controlled, thereby effectively preventing reference signals stored in the memory from being degraded due to electrical noise and/or a malfunction of an internal circuit for white balance correction of a driving a light source.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a plan view illustrating an exemplary embodiment of a display apparatus according to the present invention;

FIG. 2 is a block diagram of an exemplary embodiment of a light source driving circuit of the display apparatus shown in FIG. 1;

FIG. 3 is a schematic circuit diagram of an exemplary embodiment of the light source driving circuit shown in FIG. 2;

FIG. 4 is a schematic circuit diagram illustrating an exemplary embodiment of a connecting structure of third connector of the light source driving circuit shown in FIG. 3; and

FIGS. 5A and 5B are flowcharts illustrating an exemplary embodiment of a method for driving the light source driving circuit shown in FIG. 2.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

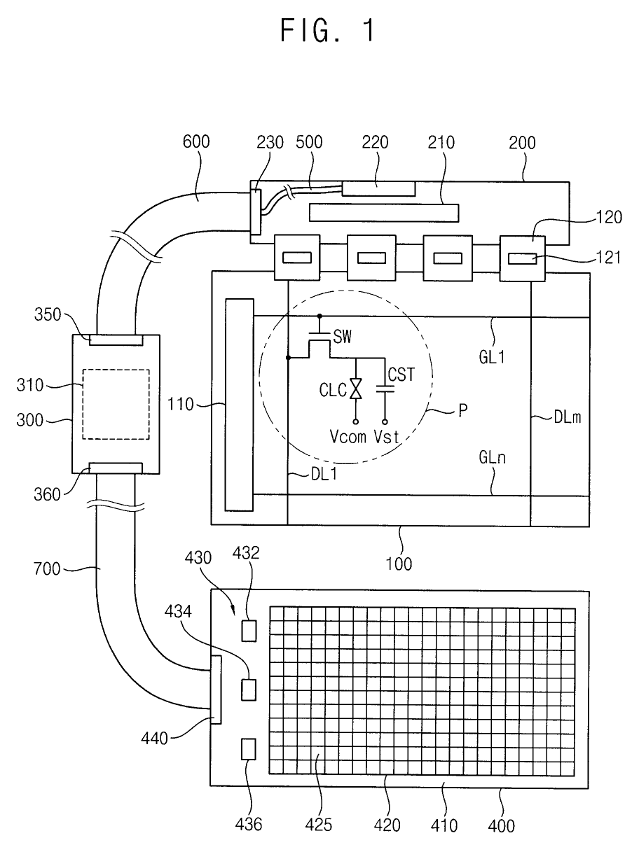

FIG. 1 is a plan view illustrating an exemplary embodiment of a display apparatus according to the present invention.

Referring to FIG. 1, a display panel includes a display panel 100, a source printed circuit board (“PCB”) 200, a light source flexible printed circuit board (“FPCB”) 300 and a light source module 400.

The display panel 100 includes two substrates (not shown) disposed opposite to, e.g., facing, each other and a liquid crystal layer interposed between the substrates. The display panel 100 according to an exemplary embodiment further includes a display area and a peripheral area substantially surrounding the display area.

Gate lines GL1 to GLn and data lines DL1 to DLm (wherein ‘n’ and ‘m’ are natural numbers) crossing the gate lines GL1 to GLn, and pixel parts P disposed in the display area and electrically connected to corresponding gate lines of the gate lines GL1 to GLn and the data lines DL1 to DLm. Each pixel part P includes a thin-film transistor (“TFT”) SW, e.g., a switching element SW, a liquid crystal capacitor CLC electrically connected to the TFT SW and a common voltage Vcom, and a storage capacitor CST electrically connected to the TFT SW and which stores a storage voltage Vst to display an image on the display panel 100.

Panel driving parts 110 and 120 for driving the display panel 100 are disposed in the peripheral area. In an exemplary embodiment, the panel driving parts 110 and 120 include a gate driving part 110 which outputs a gate signal to the gate lines GL1 to GLn and a plurality of source tape carrier packages (hereinafter referred to as “source TCPs”) 120 which output a data signal to the data lines DL1 to DLm.

The source PCB 200 is electrically connected to the display panel 100. A timing controlling part 210 is disposed on the source PCB 200. In an exemplary embodiment, the timing controlling part 210 receives a control signal and a data signal from an external graphic controller (not shown), for example. The timing controlling part 210 generates a source control signal for controlling a driving operation of the source TCP 120, a gate control signal for controlling driving operation of the gate driving part 110 and a light source control signal for controlling a driving operation of the light source module 400 based on the control signal. The source control signal according to an exemplary embodiment may include a horizontal start signal, an inversion signal and an output enable signal, for example, but alternative exemplary embodiments of the present invention are not limited thereto. The gate control signal may include a vertical start signal, a gate clock signal and an output enable signal, for example. The source control signal is outputted to the source TCP 120, while the gate control signal is outputted to the gate driving part 110.

The source PCB 200 according to an exemplary embodiment may further include a first connector 220 and a second connector 230.

The first connector 220 receives the control signal and the data signal from the host system to provide the control signal and the data signal to the timing controlling part 210. In addition, the first connector 220 receives an external control signal from an external device (not shown) for controlling a writing operation of a memory included in the light source FPCB 300, as will be described in further detail below. In an exemplary embodiment, the control signal includes a first control signal at a first level and a second control signal at a second level.

The second connector 230 is electrically connected to the first connector 220 through a first connecting member 500 to receive the external control signal therefrom. In addition, the second connector 230 is electrically connected to the light source FPCB 300 through a second connecting member 600. The second connector 230 transmits the light source control signal, received from the timing controlling part 210, to the light source FPCB 300. In an exemplary embodiment, the first connecting member 500 and the second connecting member 600 include a plurality of signal lines.

A source driving chip 121 is disposed on the source TCP 120. The source TCP 120 includes a first terminal electrically connected to the source PCB 200 and a second terminal electrically connected to the display panel 100. The source driving chip 121 receives the data signal and the data control signal from the timing controlling part 210 and converts the data signal into an analog data voltage to output the analog data voltage to the data lines DL1 to DLm.

The gate driving part 110 sequentially outputs a gate scan signal to the gate lines GL1 to GLn in response to the gate control signal received from the timing controlling part 210. The gate driving part 110 also outputs a gate on voltage and a gate off voltage received from an external device (not shown).

In an exemplary embodiment, the gate driving part 110 is integrated on the peripheral area of the display panel 100, but alternative exemplary embodiments are not limited thereto, rather, the gate driving part 110 may be disposed in a tape carrier package (“TCP”) method or a chip-on-film (“COF”) method, for example.

A light source driving circuit 310 for controlling the driving operation of the light source module 400 may be disposed on the light source FPCB 300.

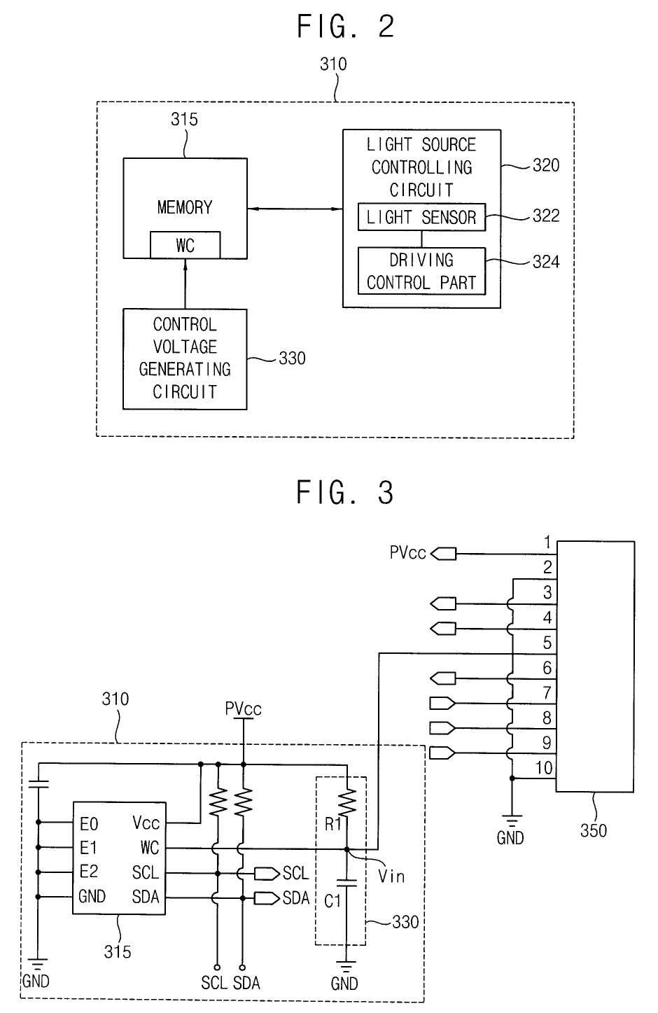

FIG. 2 is a block diagram illustrating an exemplary embodiment of a light source driving circuit of the display apparatus shown in FIG. 1.

Referring to FIGS. 1 and 2, the light source driving circuit 310 includes a memory 315, a light source controlling circuit 320 and the control voltage generating circuit 330.

The memory 315 stores a plurality of reference signals for white balance correction of a plurality of color light sources included in the light source module 400. Reference signals of the plurality of reference signals include a white color coordinate value corresponding to color light sources included in the light source module 400. In an exemplary embodiment, the reference signals may be values acquired through a test performed in a manufacturing process or step before the display apparatus is manufactured, e.g., comes out as a finished product.

The memory 315 may be, for example, an electrically erasable programmable read-only memory (“EEPROM”), e.g. a memory capable of reading and writing. The memory 315 includes a writing control terminal WC.

The light source controlling circuit 310 includes a light sensor 322 and a driving control part 324.

The light sensor 322 senses an amount of light, e.g., an amount of color light, generated from the color light source of the light source module 400 and provides a sensing signal, based on the amount of light sensed, to the driving control part 324.

The driving control part 324 generates a driving signal for driving the color light sources and provides the driving signal to the light source module 400. In an exemplary embodiment, the driving signal may be a pulse width modulation (“PWM”) signal. The driving control part 324 compensates the amount of light, e.g., the amount of color light, from the light sources based on a comparison between the sensing signal received from the light sensor 322 and the reference signals stored in the memory 315. For example, when the driving control part 324 compares the reference signals with the sensing signal to generate a light amount controlling signal, a pulse width of the driving signal output to the light source module 400 is controlled based on the light amount controlling signal.

According to exemplary embodiments, the light sensor 322 and the driving control part 324 are disposed on a single chip, but alternative exemplary embodiments are not limited thereto this example; instead, the light sensor 322 and the driving control part 324 may be formed as separate chips, for example.

The control voltage generating circuit 330 is electrically connected to the writing control terminal WC of the memory 315 to apply a predetermined control voltage to the writing control terminal WC. The control voltage generating circuit 330 receives the external control signal through a signal input part. More specifically, the control voltage generating circuit 330 applies a first control voltage at a first level and a second control voltage at a second level to the writing control terminal WC according to the external control signal to control a writing operation of the memory 315. For example, the control voltage generating circuit 330 applies the first control voltage at the first level to the writing control terminal WC when the external control signal is received to allow the memory 315 to perform the writing operation. In contrast, the control voltage generating circuit 330 applies the second control voltage at the second level to the writing control terminal WC when the external control signal is not received, to allow the memory 315 to limit, e.g., to effectively prevent and/or block, the writing operation. In an exemplary embodiment, the first level may be a low voltage level (relative to the second level) or, alternatively, may be a high level (relative to the second level).

Referring again to FIG. 1, the light source FPCB 300 further includes a third connector 350 and a fourth connector 360. The third connector 350 is electrically connected to the second connector 230 of the source PCB 200, and the fourth connector 360 is electrically connected to the light source module 400.

The light source module 400 according to an exemplary embodiment includes a driving substrate 410 and a light source part 420.

The driving substrate 410 is a PCB including a power supply wire (not shown) for supplying a driving signal to the light source part 420.

The light source part 420 is disposed on the driving substrate 410, and includes a plurality of light sources 425, e.g., a plurality of color light sources 425. For example, color light sources 425 of the plurality of color light sources 425 of the light source part 420 may include a red LED, a green LED and a blue LED.

The light source module 400 may further include light source driving chips 430 which drive the light source part 420. Moreover, the light source driving chips 430 may be disposed on a side of the driving substrate 410 on which the light source part 420 is mounted. In an exemplary embodiment, the light source driving chips 430 may include a first light source driving chip 432, a second light source driving chip 434 and a third light source driving chip 436. In addition, the first light source driving chip 432 may be a driving chip which drives the red LEDs, the second light source driving chip 434 may be a driving chip which drives the green LEDs and the third light source driving chip 436 may be a driving chip which drives the blue LEDs.

The light source module 400 may further include a fifth connector 440 electrically connected to the light source FPCB 300.

The fifth connector 440 is disposed on the driving substrate 410. The fifth connector 440 is electrically connected to the fourth connector 360 of the light source FPCB 300 through a third connecting member 700. The fifth connector 440 receives the driving signal through the fourth connector 360 to output the driving signal to the light source driving chips 430.

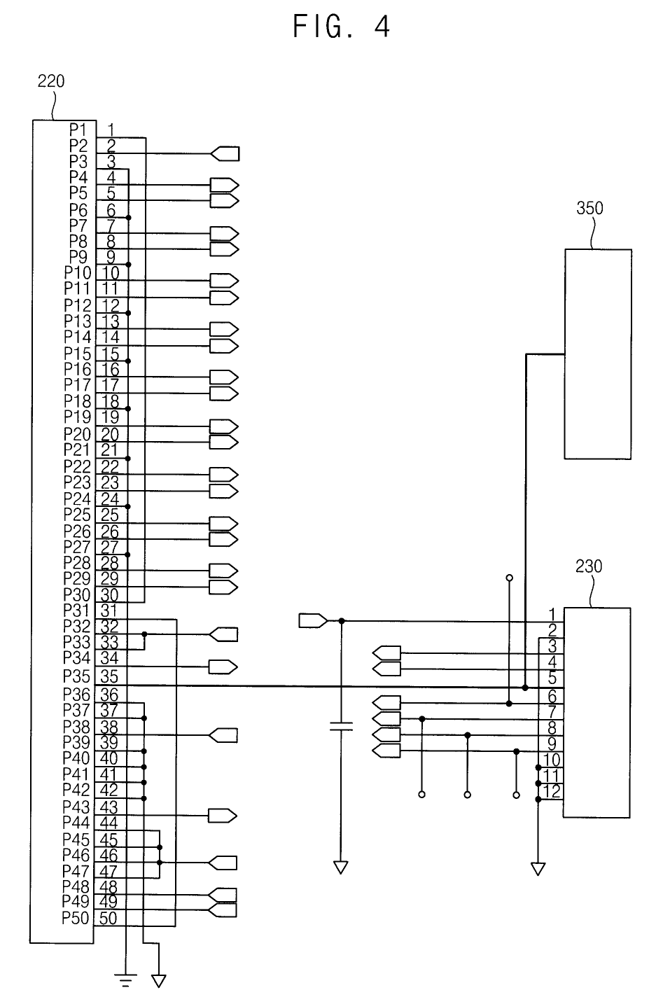

FIG. 3 is a schematic circuit diagram of an exemplary embodiment of the light source driving circuit 310 shown in FIG. 2.

Referring to FIGS. 1 to 3, the memory 315 according to an exemplary embodiment includes a first terminal E0, a second terminal E1, a third terminal E2, a fourth terminal GND, a fifth terminal SDA, a sixth terminal SCL, a seventh terminal WC and an eighth terminal Vcc. The first to third terminals E0, E1 and E2, respectively, are disposed as terminals to which data and/or an input power voltage PVcc is not applied. In addition, the first to third terminals E0, E1 and E2, respectively, are connected to a ground voltage GND via the fourth terminal GND, e.g., a ground terminal GND.

The fifth and sixth terminal SDA and SCL, respectively, receive a data signal and a clock signal, respectively, applied through a clock terminal SCL and data terminal SDA, respectively, and thereby are data input/output terminals. In addition, the fifth and sixth terminals SDA and SCA, respectively, communicate with the light source controlling circuit 320 using an inter-integrated circuit (“I2C”) method to transmit the reference signals stored in the memory 315 to the light source controlling circuit 320.

The third connector 250 includes first to tenth terminals, and the seventh terminal WC of the memory 315 is electrically connected to the fifth terminal of the third connector 350 through the control voltage generating circuit 330, e.g., through the writing control terminal WC of the memory 315.

The control voltage generating circuit 330 includes a signal input part Vin, a resistor R1 and a capacitor C1.

The signal input part Vin is electrically connected to the fifth terminal of the third connector 350 to receive the external control signal therefrom.

The resistor R1 includes a first terminal connected to the input power voltage PVcc, and a second terminal connected to the signal input part Vin and the writing control terminal WC of the memory 315.

A first terminal of the capacitor C1 is connected to the second terminal of the resistor R1, and a second terminal of the capacitor C1 is connected to the ground voltage GND. Thus, the input power voltage PVcc is divided by the resistor R1 and is charged into the capacitor C1. The capacitor C1 supplies a stable power supply to the writing control terminal WC of the memory 315, even when the input power voltage PVcc is unstable. In an exemplary embodiment, a resistance value of the resistor R1 is greater than or equal to about 10 kilohms (“kΩ”)

The control voltage generating circuit 330 applies the first control voltage at the first level to the writing control terminal WC of the memory 315 when the external control signal is received by the signal input part Vin. In contrast, the control voltage generating circuit 330 outputs the second control voltage at the second level, charged in the capacitor C1, to the writing control terminal WC of the memory 315 when the external control signal is not received by the signal input part Vin. For example, when the external control signal is applied to the signal input part Vin at a low level, the voltage charged in the capacitor C1 is discharged and the first control voltage at the first level, e.g., at the low level, is applied to the writing control terminal WC of the memory 315. Alternatively, when the external control signal is not applied to the signal input part Vin, the second control voltage at the second level is charged into the capacitor C1 and is thereby applied to the memory 315. A voltage of the second control voltage at the second level is greater than a voltage of the first control voltage.

Thus, the memory 315 performs the writing operation when the first control voltage at the first level is applied to the writing control terminal WC of the memory 315. In contrast, the memory 315 limits, e.g., effectively prevents, the writing operation when the second control voltage at the second level is applied to the writing control terminal WC of the memory 315. As a result, the memory 315 performs only the reading operation, e.g., the writing operation is limited when the second control voltage at the second level is applied to the writing control terminal WC of the memory 315.

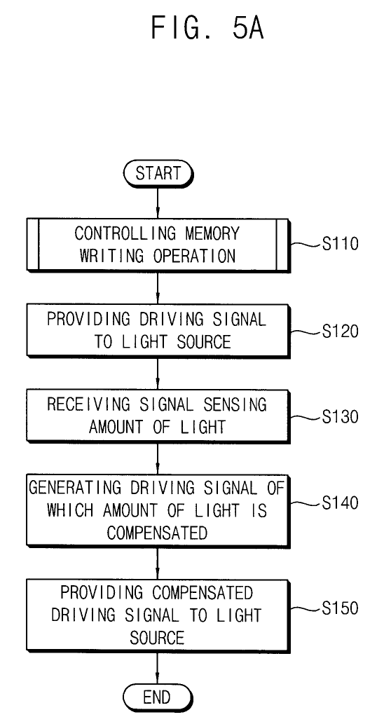

FIG. 4 is a schematic circuit diagram illustrating an exemplary embodiment of a connecting structure of a third connector of the light source driving circuit shown in FIG. 3.

As illustrated in FIG. 4, the fifth terminal of the third connector 350 is electrically connected to the fifth terminal of the second connector 230, and the fifth terminal of the second connector 230 is electrically connected to the 35th terminal of the first connector 220.

The 35th terminal of the first connector 220 is connected to an external signal line (not shown) so that the signal having the low level, serving as the external control signal, is applied only when recording the reference signals for white balance correction of the memory 315 in the manufacturing process before the display apparatus according to an exemplary embodiment comes out as a finished product, or when renewing the reference signals stored in the memory 315. The 35th terminal of the first connector 220 is not connected, so that a signal is not applied after the display apparatus is manufactured.

As described in greater detail above, since a signal is not applied to the 35th terminal of the first connector 220 after the display apparatus is manufactured, e.g., is a finished product, a signal is not applied to either the fifth terminal of the second connector 230 connected to the 35th terminal of the first connector 220 or the fifth terminal of the third connector 350.

Thus, except for a case in which the reference signals are recorded to the memory 315 or are being renewed in the memory 315, in a manufacturing process of the display apparatus according to an exemplary embodiment, the second control voltage at the second level, generated by the control voltage generating circuit 330, is applied to the writing control terminal WC of the memory 3 15 to effectively prevent, e.g., to limit, the writing operation of the memory 315. Put another way, the memory 315 allows only the writing operation to be performed after a manufacturing process of the display apparatus is completed. Accordingly, data stored in the memory 315 is effectively prevented from being damaged, e.g., degraded, due to electrical noise or a malfunction of internal elements, for example.

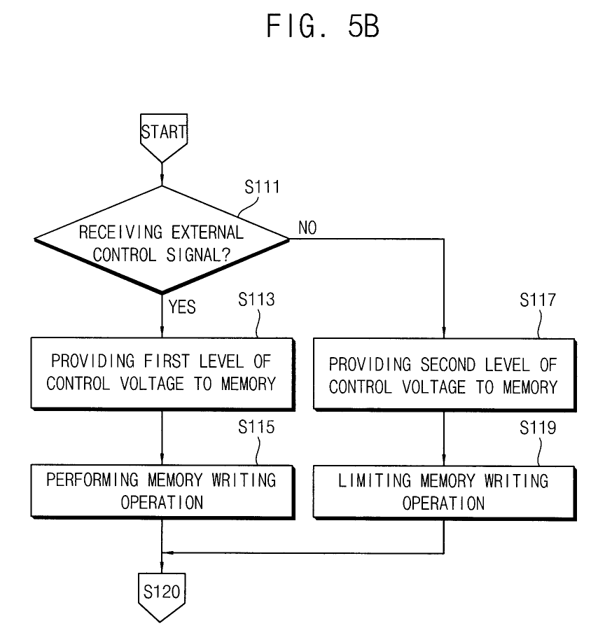

FIGS. 5A and 5B are flowcharts illustrating an exemplary embodiment of a method for driving the light source driving circuit shown FIG. 2.

Referring to FIGS. 1, 2, 3 and 5A, the control voltage generating circuit 330 applies the first control voltage at the first level or, alternatively, the second control voltage at the second level, to the memory 315 to control a writing operation of the memory 315 depending on whether the external control signal is received (step S110).

Referring to FIG. 5B, the control voltage generating circuit 330 determines whether the external control signal is received by the signal input part Vin (step S111).

Moreover in step S111, when the external control signal is received by the signal input part Vin, the control voltage generating circuit 330 provides the writing control terminal WC of the memory 315 with the first control voltage at the first level (step S113).

As a result, the memory 315 performs the writing operation when the first control voltage at the first level is applied to the writing control terminal WC (step S115). In an exemplary embodiment of the present invention, when the external control signal is applied is a case when recording the reference signals to the memory 315 is performed or, alternatively, is a case when the reference signals recorded to the memory 315 are renewed. Thus the memory 315 performs an operation of recording the reference signals to the internal device in response to a recording request, when the first control voltage at the first level is applied to the writing control terminal WC.

In step S111, when the external control signal is not received, the control voltage generating circuit 330 provides the second control voltage at the second level, charged into the capacitor C1, to the writing control terminal WC of the memory 315 (step S117).

As a result, the memory 315 limits the writing operation, e.g. prevents the writing operation, when the second control voltage at the second level is applied to the writing control terminal WC (step S119). Thus, the memory 315 performs only the reading operation.

Referring again to FIG. 5A, the driving control part 324 generates a driving signal for driving the color light sources and provides the driving signal to the light source module 400 (step S120).

The light sensor 322 senses an amount of color light generated from the color light sources of the light source module 400 and provides the driving control part 324 with sensing signal based on the amount of color light generated from the color light sources and sensed by the light sensor 322.

The driving control part 324 receives the sensing signal from the light sensor 322 (step S130).

The driving control part 324 compares the reference signals, stored in the memory 315, with the sensing signal to generate a compensated driving signal to compensate an amount color light which is outputted b the color light sources (step S140).

The driving control part 324 provides the compensated driving signal to the color light sources to compensate an amount of color light outputted by the color light sources (step S150).

According to exemplary embodiment of the present invention as described herein, a fixed level of control voltage is applied to a writing control terminal of a memory to effectively limit a writing operation of the memory except for cases in which reference signals for white balance correction of the memory light sources are recorded and renewed. Therefore, data stored in the memory is effectively prevented from being damaged due to electrical noise and/or a malfunction of an internal element, for example. Accordingly, a problem, such as in which a display quality of an image is deteriorated due to damage to the reference signals so that white balance correction with respect to the driving a light source is not satisfactorily performed, is substantially reduced and/or effectively prevented.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A method for driving a light source, the method comprising:
providing a first control voltage at a first level to a memory so that the memory performs a writing operation when an external control signal is received by a control voltage generating circuit;
providing a second control voltage at a second level to the memory so that the memory prevents the writing operation when the external control signal is not received by the control voltage generating circuit;
comparing a reference signal stored in the memory with a sensing signal based on an amount of light outputted from the light source to generate a driving signal; and
providing the driving signal to the light source to compensate the amount of light outputted from the light source.

2. The method of claim 1, wherein a voltage of the second level is greater than a voltage of the first level.

3. A light source apparatus comprising:
a light source module comprising a plurality of light sources;
a memory comprising a writing control terminal, the memory configured to store a plurality of reference signals for white balance correction of light sources of the plurality of light sources; and
a control voltage generating circuit which provides a first control voltage at a first level to the writing control terminal when an external control signal is received, and provides a second control voltage at a second level to the writing control terminal when the external control signal is not received.

4. The light source apparatus of claim 3, wherein the control voltage generating circuit comprises:
a signal input part which receives the external control signal;
a resistor comprising a first terminal connected to an input power voltage and a second terminal connected to the signal input part and the writing control terminal of the memory; and
a capacitor comprising a first terminal connected to the second terminal of the resistor and a second terminal connected to a ground voltage.

5. The light source apparatus of claim 3, wherein the memory performs the writing operation when the first control voltage at the first level is applied to the writing control terminal, and prevents the writing operation when the second control voltage at the second level is applied to the writing control terminal.

6. The light source apparatus of claim 5, wherein a voltage of the second level is greater than a voltage of the first level.

7. The light source apparatus of claim 3, wherein
the plurality of light sources comprises a plurality of color light sources, and
the reference signals comprise white color coordinate values corresponding to color light sources of the plurality of color light sources.

8. The light source apparatus of claim 3, further comprising:
a light sensor which senses a an amount of light outputted from the light sources to generate a sensing signal; and
a driving control part which compares the plurality of reference signals stored in the memory with the sensing signal to control the amount of light outputted from the light sources.

9. A display apparatus comprising:
a display panel which displays images;
a light source module disposed on a first printed circuit board, the light source module comprising a plurality of light sources which generate light to provide the light to the display panel; and
a light source driving part disposed on a second printed circuit board, the light source driving part comprising:
a memory comprising a writing control terminal, the memory configured to store a reference signal for white balance correction of light sources of the plurality of light sources, and
a control voltage generating circuit which provides a first control voltage at a first level to the writing control terminal when an external control signal is received and which provides a second control voltage at a second level to the writing control terminal when the external control signal is not received.

10. The display apparatus of claim 9, further comprising:
a panel driving part which drives the display panel; and
a timing controlling part disposed on a third printed circuit board to generate a control signal for controlling a driving timing of the panel driving part.

11. The display apparatus of claim 10, wherein the third printed circuit board comprises:
a first connector electrically connected to an external device to receive the external control signal for controlling the writing operation of the memory; and
a second connector electrically connected to the first connector to receive the external control signal, and electrically connected to the third printed circuit board to transmit the external control signal thereto.

12. The display apparatus of claim 11, wherein the second printed circuit board comprises:
a third connector electrically connected to the second connector of the third printed circuit board to receive the external control signal therefrom.

13. The display apparatus of claim 12, wherein the control voltage generating circuit comprises:
a signal input part connected to the third connector to receive the external control signal;
a resistor comprising a first terminal connected to an input power voltage and a second terminal connected to the signal input part and the writing control terminal of the memory; and
a capacitor comprising a first terminal connected to the second terminal of the resistor and a second terminal connected to a ground power voltage.

14. The display apparatus of claim 9, wherein the memory performs the writing operation when the first control voltage at the first level is applied to the writing control terminal, and prevents the writing operation when the second control voltage at the second level is applied to the writing control terminal.

15. The display apparatus of claim 14, wherein a voltage of the second level is greater than a voltage of the first level.

16. The display apparatus of claim 9, wherein
the plurality of light sources comprises a plurality of color light sources, and
the reference signals comprise white color coordinate values corresponding to color light sources of the plurality of color light sources.

17. The display apparatus of claim 9, wherein the second printed circuit board comprises:
a light sensor which senses an amount of light outputted from the light sources to output a sensing signal; and
a driving control part which controls the amount of the light outputted from the light sources based on a comparison of the sensing signal and the reference signal stored in the memory.
